(19) United States
(12) Patent Application Publication
(10) Pub. No.: US 2025/0222365 A1
(43) Pub. Date: Jul. 10, 2025

(54) MOBILE HYDRAULIC SYSTEM WITH WIRELESS TRANSMISSION OF OPERATING DATA AND METHOD FOR WIRELESS TRANSMISSION OF OPERATING DATA OF A MOBILE HYDRAULIC SYSTEM

(71) Applicant: HAWE Hydraulik SE, Aschheim (DE)

(72) Inventors: Benjamin Hasner, Aschheim (DE); Markus Neumair, Aschheim (DE)

(73) Assignee: HAWE Hydraulik SE, Aschheim (DE)

(21) Appl. No.: 19/011,996

(22) Filed: Jan. 7, 2025

(30) Foreign Application Priority Data
Jan. 8, 2024 (DE) 10 2024 200 160.0

(51) Int. Cl. A63G 31/02; B61D 33/00; G08C 17/00

(52) U.S. Cl. CPC A63G 31/02; B61D 33/0092; G08C 17/00

(57) ABSTRACT

A mobile hydraulic system includes a plurality of hydraulic units which are equipped with at least one hydraulic component and an electronic unit. The respective electronic units are configured to record operating data of the at least one hydraulic component of the respective hydraulic units. Each hydraulic unit has a wireless communication device, wherein the wireless communication devices of the respective hydraulic units are connected to each other in a common wireless network, preferably in a mesh network. The wireless communication devices are configured for wireless transmission of the recorded operating data of the hydraulic units in the wireless network.

### CROSS REFERENCE TO RELATED APPLICATION

This application claims the priority benefit from German Patent Application No. 10 2024 200 160.0, filed on Jan. 8, 2024, the entire contents of which is incorporated herein by reference in its entirety.

### FIELD

The present disclosure relates to a mobile hydraulic system in which operating data can be transmitted wirelessly via wireless communication devices in a shared network, and to a method for the wireless transmission of operating data of a mobile hydraulic system.

### BACKGROUND

Such mobile hydraulic systems regularly consist of a number of hydraulic units that can be moved relative to each other or together in a specific direction. The hydraulic units can be used for a variety of purposes, for example in mobile hydraulic applications or in amusement rides. For this purpose, the hydraulic units generally comprise at least one hydraulic component. For example, the hydraulic units can be equipped with a cylinder-piston unit. Their movement can be achieved, for example, via a hydraulic accumulator by pressurizing the cylinder-piston unit. Alternatively, the hydraulic units can be pressurized via a hydraulic pump. For example, hydraulic systems can be used in transportation, in the manufacturing sector or production sector or in amusement rides.

Such mobile hydraulic systems often contain several electronic units for controlling or recording data from the individual hydraulic units. Each of these electronic units can record operating data, in particular diagnostic and status data, of the hydraulic units and has a parameter space for device configuration. The electronic unit can be electronically connected directly to the hydraulic unit. Alternatively, the electronics unit can be connected to the hydraulic unit indirectly, for example via an interface. The electronics unit is configured to process signals coming from the hydraulic unit for data acquisition. Furthermore, the electronics unit can be configured to control or monitor the hydraulic unit. For example, the electronics unit can generate a command to open or close a hydraulic valve or monitor the position or movement of a hydraulic cylinder of the hydraulic unit.

The operating data recorded by the electronic unit can provide information about a current or past operating state of the hydraulic unit. For example, a number of actuations of the hydraulic component, a pressure of the hydraulic component, a quantity of hydraulic fluid and/or a temperature can be recorded as operating data.

For the operation of mobile hydraulic systems, only a very limited application interface (e.g. a switching input/output) is available in many areas of application. This is configured and sufficient for system operation, but inhibits additional functionalities such as the retrieval of operating data for diagnostic purposes (diagnostic data). Such an interface for a mobile hydraulic system is known, for example, from DE 10 2021 210 921 A1.

### SUMMARY

According to an embodiment of the present disclosure, a mobile hydraulic system includes a plurality of hydraulic units with at least one hydraulic component and an electronic unit. The respective electronic units are configured to record operating data of the at least one hydraulic component of the respective hydraulic units. Each hydraulic unit has a wireless communication device. The wireless communication devices of the respective hydraulic units are connected to one another in a common wireless network and are configured for wireless transmission of the recorded operating data of the hydraulic units in the wireless network.

In one embodiment, each of the wireless communication devices is configured to transmit recorded operating data of the hydraulic unit assigned to it and to receive operating data of other hydraulic units from the plurality of hydraulic units via the wireless network.

In one embodiment, each of the wireless communication devices is configured to wirelessly transmit the operating data via the wireless network to at least one other wireless communication device of the plurality of wireless communication devices.

In one embodiment, the mobile hydraulic system further includes a base station associated with the wireless network and connected to the wireless communication devices. The wireless communication devices are configured for wireless transmission of the recorded operating data of the hydraulic units to the base station.

In another embodiment, the wireless communication devices are connected to each other via common access data in the common wireless network.

In one embodiment, the wireless communication devices are connected to the respective electronic units of the hydraulic units and are supplied with electrical energy via the respective electronic units.

In another embodiment, the wireless communication devices are retrofittable to the mobile hydraulic system.

In one embodiment, the hydraulic units are movable at a predetermined distance from one another or along a predetermined trajectory.

In one embodiment, the hydraulic units are configured to actuate a safety device of the hydraulic system and the operating data transmitted by the wireless communication devices are used to monitor the safety device.

In one embodiment, the mobile hydraulic system is an amusement ride having a plurality of amusement ride passenger units. The amusement ride passenger units are provided with passenger restraint devices, and the hydraulic units are locking units for the passenger restraint devices of the amusement ride passenger units. The wireless communication devices are configured for wireless transmission of the operating data of the locking units to an amusement ride control system.

According to an embodiment of the present disclosure, the method for wirelessly transmitting operating data of a mobile hydraulic system includes the steps of: recording of the operating data of the respective at least one hydraulic component by the respective electronic units, assigning the plurality of wireless communication devices to the respective hydraulic units, connecting the plurality of wireless communication devices to each other in the common wireless network, and transmitting the recorded operating data of the hydraulic units in the common wireless network through the wireless communication devices.

In one embodiment, the step of transmitting the operational data from each of the wireless communication devices in the wireless network includes transmitting of recorded operating data of the respectively assigned hydraulic unit, receiving operating data of further hydraulic units from the plurality of hydraulic units, and transmitting of operating data to at least one other wireless communication device.

In one embodiment, the method further includes placing a base station connected to the wireless communication devices in the common wireless network and transmitting the operating data to the base station. The operating data from each of the hydraulic units is transmitted by the wireless communication devices at predetermined times and/or based on a user input.

### BRIEF DESCRIPTION

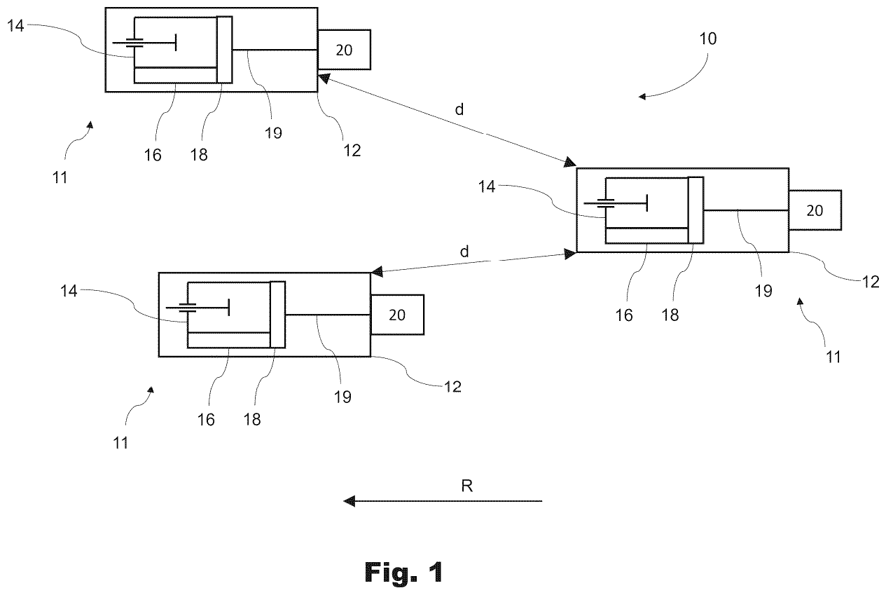

FIG. 1 depicts a mobile hydraulic system with a plurality of hydraulic units according to the present disclosure;

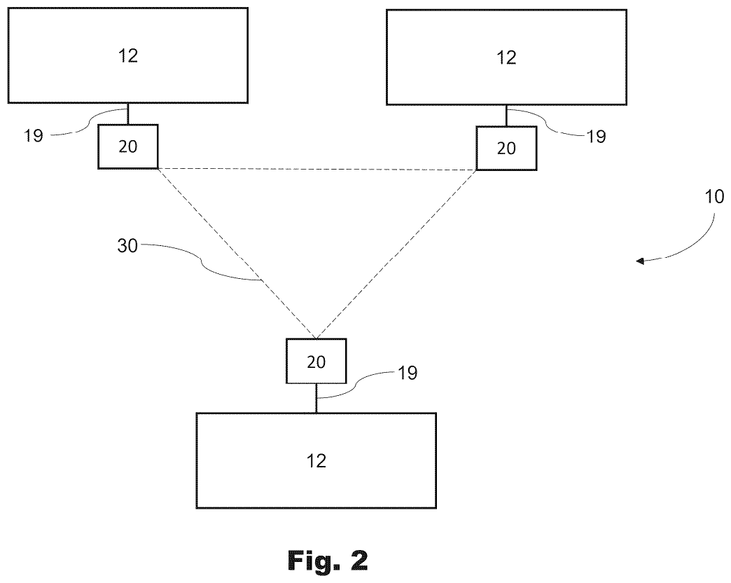

FIG. 2 depicts a plurality of communication devices of the hydraulic units according to FIG. 1, which form a common wireless network;

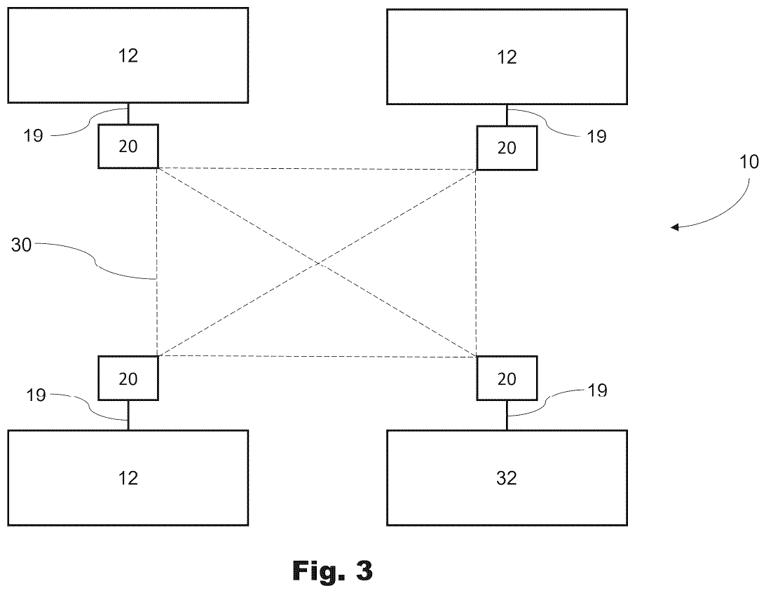

FIG. 3 depicts the wireless network according to FIG. 2 according to an alternative embodiment; and

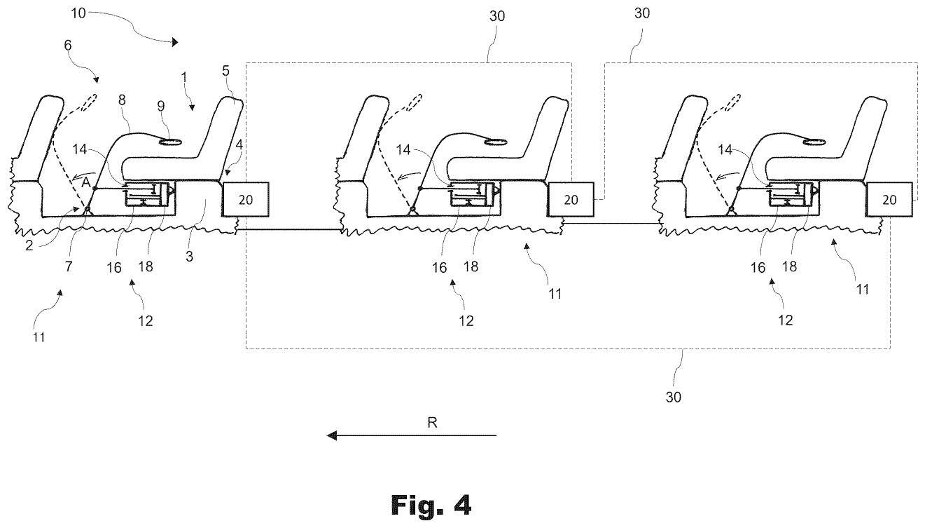

FIG. 4 depicts a mobile hydraulic system as shown in FIGS. 1 to 3, which is configured as a ride with a plurality of ride passenger units.

### DETAILED DESCRIPTION

Diagnostics during operation, i.e. when the electronics under investigation are not checked in isolation from the system, is advantageous for troubleshooting. In many cases, this requires an additional diagnostic interface due to the limited application interface.

In the case of large, distributed systems, it may be necessary to regularly record diagnostic data, partly for safety reasons, for example for restraint systems in amusement rides. If the interface used by the mobile hydraulic system does not support the retrieval of diagnostic and status data, recording this relevant data usually involves a great deal of manual effort. For example, each sub-unit must be disconnected from the mobile hydraulic system, connected to a diagnostic system to read out the data and then reconnected to the hydraulic system.

It is therefore desirable to provide an interface for a mobile hydraulic system that enables the exchange of additional (diagnostic) data parallel to normal operation. The infrastructure of the mobile hydraulic system should not be changed for diagnostic purposes and the desired data should be retrievable via an easily accessible access point. Ideally, this can be achieved without additional adaptation of the mobile hydraulic system.

The underlying objective of the disclosure is therefore to enable the retrieval of operating data of a mobile hydraulic system without influencing the operating sequence and the design of the mobile hydraulic system.

The solution to the problem is achieved with a mobile hydraulic system according to embodiments of the present disclosure and a method for the wireless transmission of operating data of such a mobile hydraulic system disclosed herein.

The mobile hydraulic system according to the present disclosure is characterized in particular compared to the hydraulic systems known from the prior art by the fact that each hydraulic unit of the system has a wireless communication device. According to the disclosure, the wireless communication devices of the respective hydraulic units are connected to each other in a common wireless network, preferably in a mesh network. The wireless communication devices are configured for wireless transmission of the recorded operating data of the hydraulic units in the wireless network. A wireless communication device is an electronic device, for example a wireless terminal, which can send and receive data via radio waves (i.e. wirelessly). The wireless communication devices form a wireless network, i.e. a network for data transmission in which data is transmitted wirelessly. Preferably, the wireless communication devices form a mesh network in which the individual communication devices each perceive themselves as part of the same network. Thus, each of the wireless communication devices recognizes all other communication devices within the mesh network and can exchange data wirelessly with them.

The mobile hydraulic system according to the disclosure offers a number of advantages. First of all, the wireless communication devices do not require central network components such as routers to form the wireless network. The operating data therefore does not have to be transmitted first to these central network components and forwarded by them. Instead, the operating data can be transmitted directly between the individual wireless communication devices. Furthermore, no complex cabling of the individual hydraulic units is required for data transmission. Wireless communication devices are also inexpensive. Consequently, the construction costs can be kept low when realizing the mobile hydraulic system according to the disclosure. Furthermore, the operating data of the hydraulic units can also be exchanged during operation of the mobile hydraulic system via the wireless communication devices. The operation of the hydraulic system is therefore not impaired for data acquisition. Finally, the time required to diagnose the mobile hydraulic system can also be reduced. With the hydraulic system according to the disclosure, it is no longer necessary to connect each individual hydraulic unit to diagnostic software to read out the operating data. Instead, the operating data can be read out at any time via simple access to the wireless network. The manual effort required to diagnose and maintain the mobile hydraulic system is therefore minimal.

Preferably, each of the wireless communication devices is configured to transmit recorded operating data of the hydraulic unit assigned to it and to receive operating data of other hydraulic units from the plurality of hydraulic units via the wireless network. This means that no additional transmission devices are required in the wireless network to which the communication devices have to send the operating data. The operating data can therefore be recorded more quickly and more easily in terms of design.

In a further embodiment, each of the wireless communication devices is configured to wirelessly transmit the operating data via the wireless network to at least one other wireless communication device of the plurality of wireless communication devices. In other words, the communication devices recognize each other as part of the same wireless network. The transmission of the operating data can thus be both faster and more secure, since the communication devices do not have to transmit the operating data to another network.

According to a further embodiment, the mobile hydraulic system also comprises a base station assigned to the wireless network and connected to the wireless communication devices. The wireless communication devices are configured for wireless transmission of the recorded operating data of the hydraulic units to the base station. The base station can be configured in the same way as the wireless communication devices. In particular, the base station can be configured to receive operating data from all hydraulic units via the wireless communication devices. The operating data of the mobile hydraulic system can be collected centrally at the base station and then read out jointly for all hydraulic units. This further simplifies the diagnosis of the mobile hydraulic system.

Preferably, the wireless communication devices are connected to each other via common access data in the common wireless network. In other words, each of the wireless communication devices dials into the wireless network using the same access data. The access data can be assigned once for each access of the wireless communication devices. For a new access of the wireless communication devices to the wireless network, a new common access data can be generated for all wireless communication devices. The common access data enables the wireless communication devices within the wireless network to recognize each other as well as to recognize communication devices not belonging to the wireless network. A protected local wireless network can therefore be set up with the aid of the common access data.

Preferably, the wireless communication devices are connected to the respective electronic units of the hydraulic units and supplied with electrical energy via the respective electronic units. The wireless communication devices can be connected to the electronic units at a distance from the electronic units via an electrical line. Alternatively, the wireless communication devices can be connected directly to the electronic units via a connection of the electronic units provided for power supply and/or data transmission. Consequently, the wireless communication devices can also be supplied with electrical energy via the electronic units during autonomous operation of the mobile hydraulic system, e.g. during a journey of the same. The operating data of the hydraulic units can therefore also be transmitted via the wireless network during operation of the mobile hydraulic system. This makes it possible to continuously record the operating data of the hydraulic units.

The wireless communication devices can be retrofitted to the mobile hydraulic system. For example, the wireless communication devices can be attached through an access opening to an interface of the hydraulic units via which the operating data was previously recorded by wire. This means that the wireless acquisition of operating data according to the disclosure can also be retrofitted to mobile hydraulic systems that have already been installed.

According to a further embodiment, the hydraulic units can be moved at a predetermined distance from each other and/or along a predetermined trajectory. The predetermined distance or the predetermined trajectory can be defined by the intended use of the mobile hydraulic system. For example, the mobile hydraulic system can be a train and the individual hydraulic units can be the wagons of the train, which are equipped with hydraulic brakes. The train's wagons then follow a trajectory determined by the railroad tracks. In particular, use in an amusement ride is also conceivable. Alternatively, the mobile hydraulic system can be a mobile transport platform for heavy or bulky goods, which is equipped with hydraulic lifting devices for lifting the goods. In this transport platform, the hydraulic lifting devices are arranged at a predetermined distance from each other in order to be able to lift and transport the goods as evenly as possible.

It is useful for the hydraulic units to be configured to actuate a safety device of the hydraulic system and for the operating data transmitted by the wireless communication devices to be used to monitor the safety device. For example, the safety device may be hydraulic brakes, hydraulic interlocks or hydraulic restraint devices of the mobile hydraulic system. The wireless transmission of the recorded operating data can be used to monitor the fault-free functioning of the safety device and thus ensure the safety of the mobile hydraulic system.

In a further embodiment, the mobile hydraulic system is a ride with a plurality of ride passenger units. The amusement ride passenger units are provided with passenger restraint devices and the hydraulic units are locking units for the passenger restraint devices. Preferably, the wireless communication devices are configured for wireless transmission of the operating data of the locking units to a ride controller.

The ride is intended to amuse people, whereby very considerable forces or accelerations are exerted on the passengers. For safety reasons, passenger restraint devices are therefore provided to secure the passengers to the passenger seat they are occupying so that they cannot leave the passenger seat (seat, reclining area, standing area, etc.). Depending on the individual ride, the passenger restraint device also further restricts the freedom of movement of the passenger concerned.

Commonly used restraint elements are, for example, restraining bars which fix the passenger, for example, at the shoulders, chest, back, stomach, hips and/or legs. Such restraining bars or other restraint elements can, in particular, be pivotably attached to the structure of the passenger unit, which also includes the passenger seat, in such a way that they can be locked in several different positions to adapt to the individual body size of the passenger concerned.

Conventional locking systems used are ratchets or comparable mechanical locking gears. With hydraulic locking elements, which are also already in use, the locking function is typically based on hydraulic fluid being sealed in a hydraulic cylinder working chamber, the volume of which changes with the position of the restraint element or the piston rod. This allows the restraint element to be locked in different positions. The hydraulic cylinder is part of a locking unit that has a further function in addition to the locking function for the restraint element. It is suitable and configured to actively open the restraint element after it has been unlocked. In this way, the restraining bars or other restraint elements in all passenger units of the ride can be opened simultaneously and without the intervention of the passengers by the assigned hydraulic adjuster, which enables a quick and smooth passenger change. In addition to the typically double-acting hydraulic cylinder, the hydraulic adjuster also has a hydraulic accumulator and an electronic unit with a sensor arrangement. The hydraulic accumulator stores hydraulic fluid under pressure and is charged by hydraulic fluid displaced from the hydraulic cylinder when the restraint element is closed. When the valve is in the corresponding position, the hydraulic cylinder is pressurized via the hydraulic accumulator with reverse flow direction to open the restraint element. To ensure that the restraint element is closed or open, the position of the piston rod is monitored via the sensor arrangement. This allows potential safety risks to be minimized even before the vehicle starts moving.

For these locking units, it is essential that the restraint element is securely fixed in the desired closed position for safety reasons. Even minor leaks could cause the restraint element to open slightly over time, which could lead to dangerous situations for passengers while the ride is in motion.

For this reason, the locking units are checked for proper functioning at regular intervals, usually several times a week. For this purpose, the tightness of the locking unit is tested by an instructed specialist. This can be done, for example, by installing a test device or by monitoring the movement of a closed bar over time, for example using a sensor. If one of the locking units does not exhibit the required sealing over the test period during this functional test, it must be replaced in order to minimize the risk of accidents.

This type of test is extremely reliable and has proven itself over the years. However, this functional test is time-consuming and cost-intensive. On the one hand, appropriate testing equipment must be available. On the other hand, a test must be carried out for each locking unit of a ride. As some modern rides offer space for up to 30 passengers, a total test time of ten hours can be expected, assuming a test period of 10 minutes per locking unit (installation of the test device, testing, removal of the test device) and two locking units per passenger seat. Of course, the total test time can be minimized by using several test devices and several specialists, although this would then entail correspondingly higher costs.

With the wireless transmission of operating data according to the disclosure, the individual locking units can be tested more easily and quickly. When the operating data of the locking units is transmitted to a ride control system, the latter can also already evaluate the operating data, which further simplifies the inspection for the specialist.

According to the disclosure, a method for wirelessly transmitting operating data of a mobile hydraulic system described above is also proposed. The method comprises the steps of: recording the operating data of the respective at least one hydraulic component by the respective electronic units; assigning the plurality of wireless communication devices to the respective hydraulic units; connecting the plurality of wireless communication devices to each other in the common wireless network; and transmitting the recorded operating data of the hydraulic units in the common wireless network by the wireless communication devices.

The method is carried out with the aspects of the mobile hydraulic system described above. The technical advantages described for the individual features of the mobile hydraulic system are thus also achieved with the method according to the disclosure.

Preferably, the step of transmitting the recorded operating data is performed by each of the wireless communication devices in the wireless network and comprises at least one of the following: transmitting recorded operating data of the respective associated hydraulic unit, receiving operating data of further hydraulic units from the plurality of hydraulic units, and/or transmitting operating data to at least one further wireless communication device. Each of the wireless communication devices can therefore be used both as a transmitter and as a receiver and further transmission devices within the wireless network can be dispensed with.

Preferably, the method further comprises the following steps: providing a base station connected to the wireless communication devices in the common wireless network; and transmitting the operating data to the base station. The operating data of all hydraulic units can be collected at the base station and then evaluated together if necessary.

In a further embodiment of the proposed method, operating data from each of the hydraulic units is transmitted by the wireless communication devices at predetermined times and/or based on a user input. The process sequence can thus be adapted to the intended use of the mobile hydraulic system or configured according to the respective user specifications.

FIG. 1 shows a mobile hydraulic system 10 with a plurality of hydraulic units 12 according to the present disclosure. The mobile hydraulic system 10 can be used in transportation, for example as a train 10 with a plurality of wagons 11. Alternatively, the mobile hydraulic system 10 can also be used in the manufacturing process of goods, for example as a production plant 10 with a plurality of movable production units 12. It is also conceivable to use the mobile hydraulic system as an amusement ride 10 with a plurality of amusement ride passenger units 11 for the amusement of persons. For the sake of simplicity, the following is based on the example of the amusement ride passenger units 11, see also FIG. 4.

The individual amusement ride passenger units 11 can be moved relative to each other at a predetermined distance d. The amusement ride passenger units 11 can be mechanically connected to each other in order to maintain the specified distance d. Alternatively or additionally, the individual amusement ride passenger units 11 can be moved with the aid of a guide in order to maintain the predetermined distance d. Furthermore, the individual amusement ride passenger units 11 can be moved along a predetermined trajectory R, for example along a railroad track. The trajectory R can be two-or three-dimensional, so the amusement ride passenger units 11 can be moved both vertically and horizontally along the trajectory R. In other words, the individual amusement ride passenger units 11 of the hydraulic system 10 are movable, so the hydraulic system 10 is a mobile hydraulic system.

To carry out hydraulic work, each amusement ride passenger unit 11 comprises a hydraulic unit 12, each of which has at least one hydraulic component 14, 16. In the exemplary embodiment according to FIG. 1, two hydraulic components 14, 16 are provided, namely a cylinder-piston unit 14 with a hydraulic accumulator 16. However, this embodiment is not to be understood restrictively. A hydraulic pump or another comparable hydraulic device can also be used instead of the cylinder-piston unit 14. The cylinder-piston unit 14 is supplied with pressure via the hydraulic accumulator 16.

Furthermore, the hydraulic units 12 each comprise an electronic unit 18. The electronic unit 18 within the meaning of the disclosure is an electronic device which, for example, generates control signals for controlling the hydraulic components 14, 16. Furthermore, the electronic unit 18 receives signals from the hydraulic components 14, 16, which provide information about at least one operating parameter of the hydraulic components 14, 16. From these signals, the electronic unit 18 determines operating data of the hydraulic unit 12. The operating data provide information about an operating state of the respective hydraulic unit 12. For example, the operating data can comprise a number of actuations of the hydraulic unit 12 or a temperature.

The electronic units 18 can transmit the recorded operating data of the hydraulic units 12 to wireless communication devices 20 for data exchange. In the embodiment shown in FIG. 1, the communication devices 20 are connected to the electronic units 18 by wire via a connection 19. In this case, the communication devices 20 are supplied with electrical energy from the electronic units 18 via the connection 19. The connection 19 can also be wireless. Of course, the wireless communication devices 20 can also be configured as part of the respective electronic unit 18.

With reference to FIGS. 2 and 3, the data transmission of the operating data of the hydraulic units 12 carried out by the wireless communication devices 20 is explained in more detail below.

FIG. 2 schematically shows a data transmission of operating data of the mobile hydraulic system 10 according to FIG. 1. The operating data is recorded by the electronic units 18 of the respective hydraulic units 12. The operating data can be used to draw conclusions about the operating status of the respective hydraulic units 12 or the mobile hydraulic system 10. For example, the operating data can be used to detect a malfunction of the hydraulic units 12. Another example is that the operating data can be used to determine the remaining operating time of the hydraulic units 12. After this remaining operating time has elapsed, maintenance or replacement of the hydraulic units 12 may be planned. Furthermore, it may be necessary to regularly record the operating data of the hydraulic units 12, for example due to safety requirements, in order to ensure the functionality of the hydraulic system 10.

The recorded operating data is transmitted to the communication devices 20 via the connection 19 (wired or wireless). In the embodiment shown, each of the communication devices 20 is associated with a hydraulic unit 12 and receives operating data from the hydraulic unit 12 which has been acquired by the electronic unit 18 of the hydraulic unit 12 as described above. The communication devices 20 are electronic devices which are configured both for transmitting and for receiving operating data of the hydraulic units 12 via radio waves (i.e. wirelessly). For example, the wireless communication devices 20 can be mobile terminals.

The wireless communication devices 20 are connected to each other in or form a common wireless network 30. To form the wireless network 30, each of the wireless communication devices 20 is wirelessly connected to at least one other wireless communication device 20 in the wireless network 30 for data transmission, as indicated by the dashed lines in FIG. 2. Each of the wireless communication devices 20 can thus receive operational data from all other wireless communication devices 20 and transmit operational data to all other wireless communication devices 20. The data transmission between the wireless communication devices 20 can either take place directly, i.e. from one communication device 20 to the other communication device 20 connected to it. Furthermore, the data transmission can also take place indirectly via one or more intermediate communication devices 20. The intermediate communication devices 20 are also connected to each other at least in pairs in the wireless network 30.

The operating data transmitted in the wireless network 30 can be retrieved wirelessly at each of the wireless communication devices 20 by a higher-level control unit (not shown) of the mobile hydraulic system 10. The control unit uses the operating data to determine an operating state of the mobile hydraulic system 10 and can change this operating state using control signals. The control unit can also use the operating data to determine a malfunction of the mobile hydraulic system 10 and take appropriate corrective measures or issue a warning. Alternatively or additionally, the operating data can be retrieved wirelessly by a specialist of the mobile hydraulic system 10, for example via a diagnostic interface of the wireless network 30, for maintenance purposes. The diagnostic interface can be provided on one of the wireless communication devices 20 or can also be configured as a wireless communication device 20. Alternatively, a direct connection to the wireless network 30 can be established via a wireless terminal device, for example a PC. In this case, the operating data can be retrieved directly from the wireless terminal device. The operating data retrieved wirelessly via the diagnostic interface can be used to carry out diagnostics and, if necessary, maintenance of the mobile hydraulic system 10.

Preferably, the wireless network 30 formed by the wireless communication devices 20 is a mesh network. In the mesh network, data exchange between all wireless communication devices 20 is possible directly, i.e. without additional network components such as routers or the like. In particular, all wireless communication devices 20 can be directly connected to each other in the mesh network, as shown by the dashed line in FIG. 2. The operating data can therefore be transmitted directly between all wireless communication devices 20. Data transmission via intermediate communication devices 20, as described above, is also possible. Each of the wireless communication devices 20 recognizes all other wireless communication devices 20 in the mesh network as part of the common wireless network 30. The transmission of operating data by the wireless communication devices 20 therefore does not take place across networks between different networks, but within the common wireless network 30. This increases the security of the data transmission. Furthermore, the direct communication between the wireless communication devices 20 also increases the speed of data transmission.

Furthermore, the configuration of the wireless network 30 as a mesh network has the advantage that data can also be transmitted to network components to which there is no direct connection. For example, the spatial distance between two communication devices 20 can be very large. The direct connection between two communication devices 20 could also be blocked by obstacles, so that direct data transmission between these communication devices 20 would then no longer be possible. However, the linking of the individual communication devices 20 in the mesh network makes it possible for individual communication devices 20 to act as a bridge via which operating data can also be transmitted between communication devices 20 that are not directly connected.

Due to the wireless design as shown in FIG. 2, data transmission of the operating data can be carried out at any time and simultaneously by each of the hydraulic units 12. The operating data of the mobile hydraulic system 10 can therefore be constantly updated and recorded in real time. There is also no need to intervene in the operating sequence of the mobile hydraulic system 10, as the operating data can be transmitted from each of the wireless communication devices 12, for example to a higher-level control unit of the mobile hydraulic system 10, at any time without first having to establish a cable connection with the individual hydraulic units 12. Finally, a wireless transmission of the operating data according to the disclosure can also be made possible in already existing hydraulic systems 10 due to the simple availability of wireless communication devices 20.

FIG. 3 shows an alternative embodiment of the wireless network 30 for wireless data transmission of the operating data of a mobile hydraulic system 10. According to the embodiment shown in FIG. 3, the wireless network 30 comprises a base station 32. The base station 32 is associated with the wireless network 30 and is connected to the wireless communication devices 20.

As shown in FIG. 3, the base station 32 is connected to a wireless communication device 20 via a wireless or wired connection 19. The communication device 20 connected to the base station 32 is part of the wireless network 30 and can communicate with all other wireless communication devices 20 for data exchange, as explained above in connection with FIG. 2.

The embodiment of FIG. 3 differs from the wireless network 30 shown in FIG. 2 in that the communication devices 20 are configured to transmit the recorded operating data of the hydraulic units 12 to the base station 32 for retrieving the operating data. The base station 32 can be provided with a memory unit for storing the operating data. The operating data stored by the base station 32 can be retrieved at any time and/or transmitted by the base station 32, for example for diagnostic purposes, to a higher-level control unit of the mobile hydraulic system 10. The base station 32 therefore enables the operating data of the hydraulic units 12 to be collected or forwarded together via the wireless network 30.

FIG. 4 schematically shows an application form of the mobile hydraulic system as an amusement ride 10 for the amusement of people. The amusement ride 10 comprises a plurality of interconnected amusement ride passenger units 11. The amusement ride passenger units 11 move together along a predetermined trajectory R, for example a track of the amusement ride 10.

The plurality of amusement ride passenger units 11 are described below with reference to the first amusement ride passenger unit 11 in the direction of the trajectory R (i.e. on the left in the plan view of FIG. 4). However, the other amusement ride passenger units 11 are constructed analogously to the first amusement ride passenger unit 11 in terms of their design features. For reasons of clarity, some of the reference signs of the other amusement ride passenger units 11 are therefore omitted in FIG. 4.

The amusement ride passenger units 11 illustrated in FIG. 4 comprise a passenger support 1 and a passenger restraint device 2. The passenger support 1 is configured as a seat 5 mounted on a base structure 3 of the ride 10, namely on a seat support 4. And the passenger restraint device 2 comprises a position-adjustable restraint element 6 in the form of a restraining bar 8 mounted on the base structure 3 of the ride so as to pivot on a joint 7 (see arrow A), with a padded pressure plate 9, by means of which a passenger sitting on the seat 5 is fixed on the seat 5 by the thighs near the hips.

A lockable locking unit 12 acts on the restraining bar 8 as an application example of a hydraulic unit 12. The locking unit 12 comprises a cylinder-piston unit 14 and a hydraulic accumulator 16. The cylinder-piston unit 14 and the hydraulic accumulator 16 represent application examples of hydraulic components 14, 16. The locking unit 12 is provided with an electronic unit 18 for acquiring operating data of the locking unit 12. The locking unit 12 enables hydraulic locking and opening of the restraining bar 8 in order to hold the passenger seated on the seat 5 securely in the seat 5 during a journey of the ride 10.

In the embodiment example shown in FIG. 4, the operating data includes a number of locking operations of the locking unit 12 as well as measured values that allow direct conclusions to be drawn about the sealing of the hydraulic system 10. The number of locking processes per amusement ride passenger unit 11 is of great relevance for ensuring the safety of the passengers of the ride 10. It is therefore advantageous to record and transmit this operating data as completely or as frequently as possible. For this purpose, each of the amusement ride passenger units 11 comprises a wireless communication device 20.

The wireless communication devices 20 are connected together in the wireless network 30 described with reference to FIGS. 2 and 3. Thus, even while the amusement ride 10 is moving, operating data can be acquired from all locking units 12 of the amusement ride 10 and transmitted via the wireless network 30. The recorded operating data can be transmitted to a non-displayed ride controller and evaluated at predetermined times, for example when the ride 10 comes to a stop. This does not affect the operation of the ride 10.

1. A mobile hydraulic system, comprising:
a plurality of hydraulic units with at least one hydraulic component and an electronic unit,
wherein the respective electronic units are configured to record operating data of the at least one hydraulic component of the respective hydraulic units,
wherein each hydraulic unit has a wireless communication device, the wireless communication devices of the respective hydraulic units being connected to one another in a common wireless network,
wherein the wireless communication devices are configured for wireless transmission of the recorded operating data of the hydraulic units in the wireless network.

2. The mobile hydraulic system according to claim 1, wherein each of the wireless communication devices is configured to transmit recorded operating data of the hydraulic unit assigned to it and to receive operating data of other hydraulic units from the plurality of hydraulic units via the wireless network.

3. The mobile hydraulic system according to claim 1, wherein each of the wireless communication devices is configured to wirelessly transmit the operating data via the wireless network to at least one other wireless communication device of the plurality of wireless communication devices.

4. The mobile hydraulic system according to claim 1, wherein the mobile hydraulic system further comprises a base station associated with the wireless network and connected to the wireless communication devices,
And wherein the wireless communication devices are configured for wireless transmission of the recorded operating data of the hydraulic units to the base station.

5. The mobile hydraulic system according to claim 1, wherein the wireless communication devices are connected to each other via common access data in the common wireless network.

6. The mobile hydraulic system according to claim 1, wherein the wireless communication devices are connected to the respective electronic units of the hydraulic units and are supplied with electrical energy via the respective electronic units.

7. The mobile hydraulic system according to claim 1, wherein the wireless communication devices are retrofittable to the mobile hydraulic system.

8. The mobile hydraulic system according to claim 1, wherein the hydraulic units are movable at a predetermined distance from one another or along a predetermined trajectory.

9. The mobile hydraulic system according to claim 1, wherein the hydraulic units are configured to actuate a safety device of the hydraulic system and the operating data transmitted by the wireless communication devices are used to monitor the safety device.

10. The mobile hydraulic system according to claim 8, wherein the mobile hydraulic system is an amusement ride having a plurality of amusement ride passenger units, the amusement ride passenger units being provided with passenger restraint devices, and
wherein
the hydraulic units are locking units for the passenger restraint devices of the amusement ride passenger units.

11. The mobile hydraulic system according to claim 10, wherein the wireless communication devices are configured for wireless transmission of the operating data of the locking units to an amusement ride control system.

12. The method for wirelessly transmitting operating data of a mobile hydraulic system according to claim 1, the method comprising the steps of:
recording of the operating data of the respective at least one hydraulic component by the respective electronic units,
assigning the plurality of wireless communication devices to the respective hydraulic units,
connecting the plurality of wireless communication devices to each other in the common wireless network, and
transmitting the recorded operating data of the hydraulic units in the common wireless network through the wireless communication devices.

13. The method according to claim 12, wherein the step of transmitting the operational data from each of the wireless communication devices in the wireless network comprises:
transmitting of recorded operating data of the respectively assigned hydraulic unit,
receiving operating data of further hydraulic units from the plurality of hydraulic units, and
transmitting of operating data to at least one further wireless communication device.

14. The method according to claim 12, wherein the method further comprises the following steps:
placing a base station connected to the wireless communication devices in the common wireless network, and
transmitting the operating data to the base station.

15. The method according to claim 12, wherein operating data from each of the hydraulic units is transmitted by the wireless communication devices at predetermined times and based on a user input.
